(19) United States
(12) Patent Application Publication
(10) Pub. No.: US 2011/0139949 A1
(43) Pub. Date: Jun. 16, 2011

(54) FOLIAGE HOLDER

(76) Inventor: Todd Duerr, Nekoosa, WI (US)

(21) Appl. No.: 12/858,412

(22) Filed: Aug. 17, 2010

Related U.S. Application Data
(60) Provisional application No. 61/234,481, filed on Aug. 17, 2009.

(51) Int. Cl. F16B 2/10; F16M 13/02

(52) U.S. Cl. 248/222.14; 248/316.5; 248/223.31

(57) ABSTRACT

A foliage holder for securing a piece of foliage to a support and provide an overhanging element adjacent to or within an open area to attract wildlife.

### CROSS-REFERENCE TO RELATED APPLICATION

The present application claims priority to an earlier filed U.S. provisional application Ser. No. 61/234,481, filed on Aug. 17, 2009, the disclosure of which is incorporated herein by reference.

### BACKGROUND

It is common for hunters seeking to attract game to certain locations to clear and plant plot with food or forage plants that are favored by the desired game animals. It is also known to do this as a way of attracting animals for viewing as opposed to hunting. It is also known that many wildlife animals may prefer to feed on crops that are cultivated for human or livestock food.

While such food locations are known, it Is also known that some more skittish animals prefer to have cover in the form of overhanging foliage along the edges or directly adjacent to the food. Other antlered animals, such as but not limited to deer, may prefer to have scrapes available directly adjacent the food plots, have appropriate structure for removed velvet from antlers or leaving signs of their territory for other animals. Some animals use natural scents left on the foliage, such as by licking, and may use the foliage as a way of social communication.

Unfortunately, when clearing ground for such food plots, clearing of the trees and undergrowth often leaves the edge of the plot with generally vertical foliage and very little overhanging branches. Similarly, along the edges of established crop fields, the foliage tends to be withdrawn from the edge of the actual tilled and planted areas of the field. Movement of farm equipment and implements through the field will tend to disturb and push back the surrounding foliage, leaving a buffer about the field with no overhanging foliage. Farm roads, logging roads, and other manmade or naturally occurring thoroughfares or paths in the woods may also be similarly configured.

It is also known that other game animals are attracted to clearing, either natural or manmade that may have overhanging branches or other foliage along the edges.

Devices and methods of holding non-naturally occurring and positioned foliage overhanging such open spaces are desirable.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a side perspective view of a foliage holder according to the present disclosure.

FIG. 2 is a top perspective view of the foliage holder of FIG. 1.

FIG. 3 is a second side perspective view of the foliage holder of FIG. 1.

FIG. 4 is a third side perspective view of the foliage holder of FIG. 1.

FIG. 5 is a side perspective view of a second embodiment of a foliage holder according to the present disclosure.

FIG. 6 is a second side perspective view of the foliage holder of FIG. 5.

FIG. 7 is a closer perspective view of the top of the foliage holder of FIG. 5.

FIG. 8 is a closer perspective view of the lower portion of the foliage holder of FIG. 5.

FIG. 9 is a perspective view of a center support of the foliage holder of FIG. 5, with a lower support base removed.

FIG. 10 is a closer view of a lower portion of a foliage holder according to the present disclosure.

FIG. 11 is a side perspective view of a fourth embodiment of a foliage holder according to the present disclosure.

FIG. 12 is a second side perspective view of the foliage holder of FIG. 11.

FIG. 13 is a top perspective view of the foliage holder of FIG. 11.

FIG. 14 is a third side perspective view of the foliage holder of FIG. 11.

FIG. 15 is a rear perspective view of the foliage holder of FIG. 11.

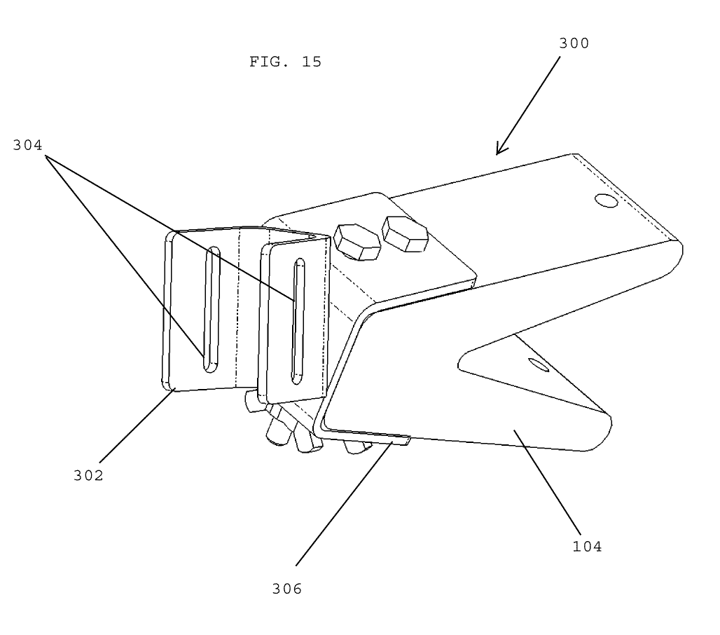

FIG. 16 is a perspective view of the top portion of the foliage holder of FIG. 7, with a support arm attached to the bracket.

FIG. 17 is a perspective view of the foliage holder of FIG. 11, with a support arm attached to the bracket.

FIG. 18 is a perspective view of the foliage holder of FIG. 1, with a support arm attached to the bracket.

FIG. 19 is a photograph of a foliage holder according to the present disclosure with a branch held by the holder and a support providing support to the branch.

FIG. 20 is a closer photograph of the foliage holder of FIG. 19.

### DESCRIPTION

Reference will now be made in detail to exemplary aspects of the present invention which are illustrated in the accompanying drawings. Wherever possible, the same reference numbers will be used throughout the drawings to refer to the same or like parts.

As shown in the FIGS. attached hereto, a variety of holder devices are provided which are configured to secure and hold cut trees or branches in such a position as to overhang existing game food plots or tilled fields. Where reference has been made to foliage, it is not intended that this reference be limited to any particular type of nature of branch or other wooden structure to be held by the device of the present disclosure. The foliage may be a single branch or may have a plurality of branches. The foliage may include leaves, needles or other types of greenery or may be bare of any natural greenery. The foliage may include secondary growth, such as but not limited to moss or other types of growth. Manmade branches or elements of foliage may be used with the device of the present disclosure without straying from the scope of the present disclosure.

All of the embodiments of holder described and illustrated herein include some common elements and where they differ primarily in the nature of attachment of the embodiments to existing ground or structures. All of the embodiments incorporate a support member that is generally V-shaped that permits the insertion of a branch or tree trunk of the foliage to be supported through the larger outer open end. Once the branch or trunk is within the V of the support member, a clamping device or keeper is extended across the open end of the support member. The clamp or keeper will serve to prevent movement of the branch or trunk out of the V.

It is desirable that the support member be made of a resilient deformable material that will provide some degree of friction to secure the branch or trunk with the V without excessive movement. The material should also permit some variation in size of the branch or trunk as moisture content and thus the size of the branch or trunk varies. Having a flexible material and a V shape also permit branches of a variety of sizes and shapes to be held within the V and secured. The keeper or clamp may include but is not limited to a screw or bolt and nut assembly extending through an outer portion of the V, a removable strap such as a hook-and-loop closure extending across an outer end of the V, and other similar or analogous means and methods of closing the V and providing some degree of compression of the arms of the V inward about the branch or trunk.

Experience with the present device has shown that foliage may need to extend as far as 5 yards from the edge of the surrounding foliage to be effective as protective overhanging cover, a suitable velvet removal structure, a licking station and a desirable scrape. As such, it is anticipated that the diameter of appropriate branches or trunks may be as much as 3 inches or more near the butt where the device of the present disclosure would attach to them. Thus, it is anticipated that the device of the present disclosure be configured to at least hold branches or trunks that are up to 3 inches or more in diameter. However, it is not the intention of the present disclosure to limit the range of sizes that the device described herein will be able to hold.

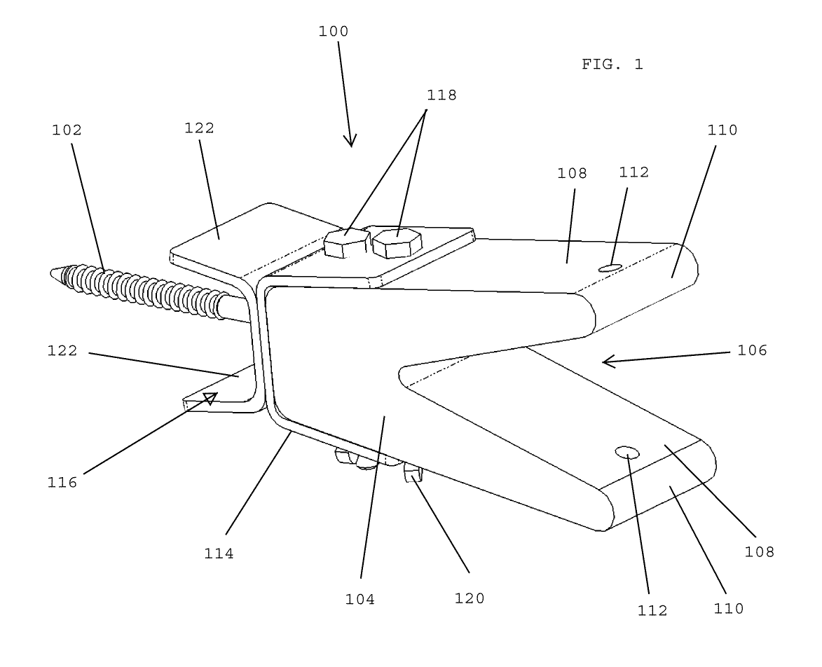

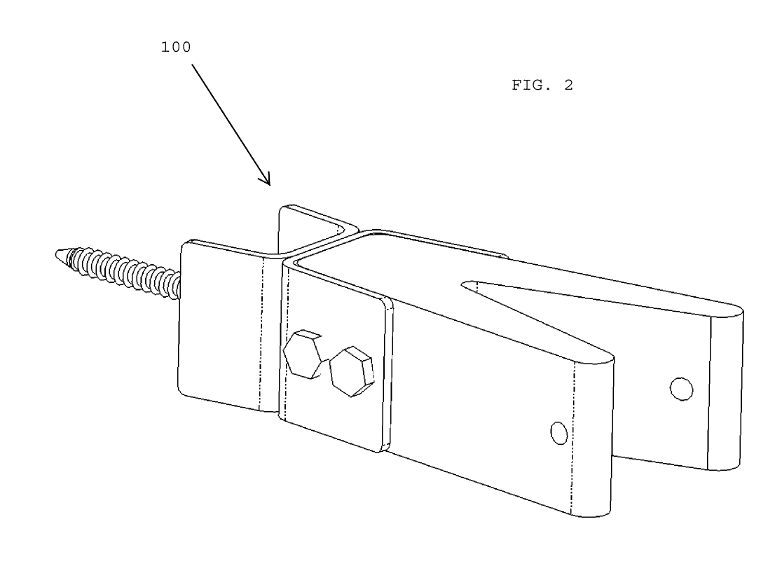

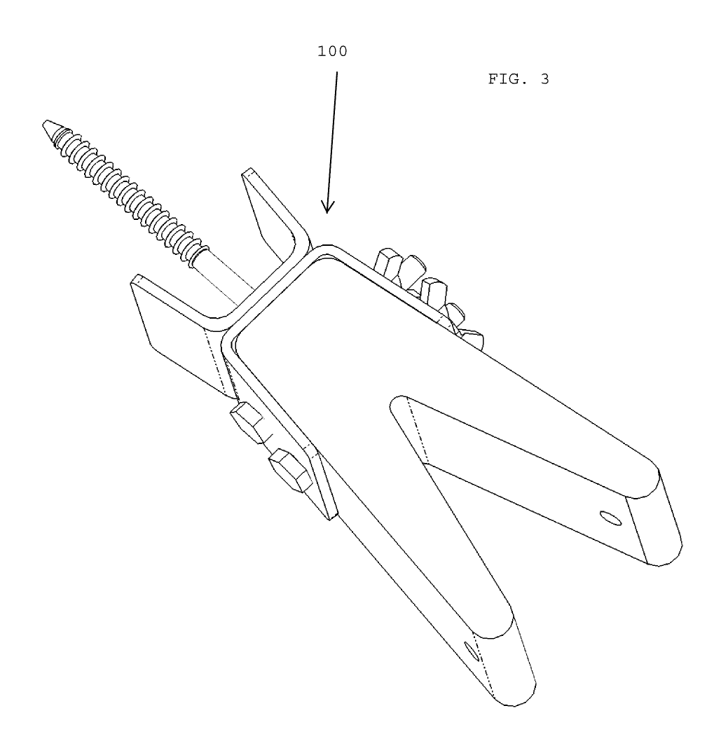

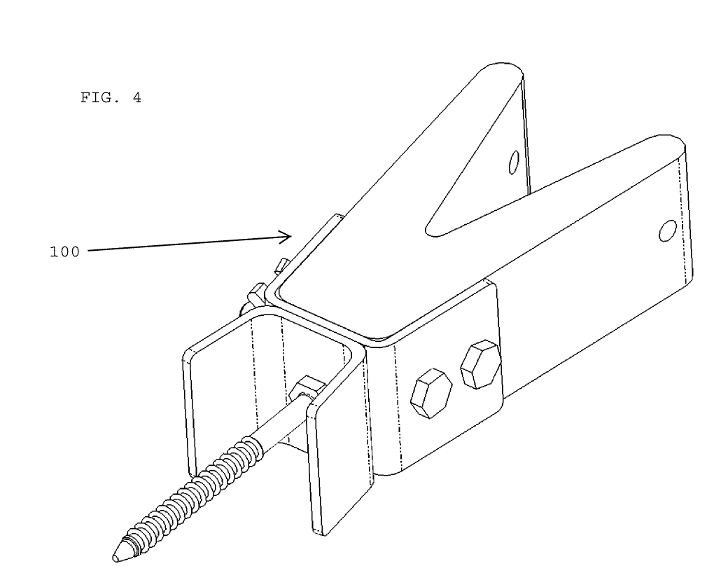

FIGS. 1 to 4 illustrate a first holder embodiment 100 that is adapted to screw into existing trees along the edge of the area where the overhanging foliage is desired. For this holder 100 to be effective is performing the desired function, trees of sufficient size need to be located near the area where the overhang is desired to be established. Such trees will be large enough to accept and hold a threaded shaft 102 and support a support member 104 of holder 100. In addition to trees, it is anticipated that shaft 102 may be inserted into existing manmade structures or fence posts that may adjacent where the overhang is desired.

Support member 104 may include a pair of arms 108 defining a V 106 for insertion of a branch or trunk. At a outer end 110 of each arm 108 may be openings 112 for receiving fasteners for securing a branch or trunk within V 106. Support member 104 may be held within a bracket 114 by one or more fasteners such as screws 118 extending through the bracket and the member. Easily removable thumbscrews or wing nuts 120 may be used to secure screws 118 and member 104 to bracket 114. A second bracket 116 may be provided through which threaded shaft 102 may protrude. Brackets 116 and 118 may be rotatably attached to each other or may be provided in a fixed orientation. Bracket 118 may include one or more rearward extensions 122 that are configured to engage a tree, post of other structure to which holder 100 may be desirably attached. Extensions 122 may be helpful in securing holder 100 in a desired orientation against the post, tree or other support.

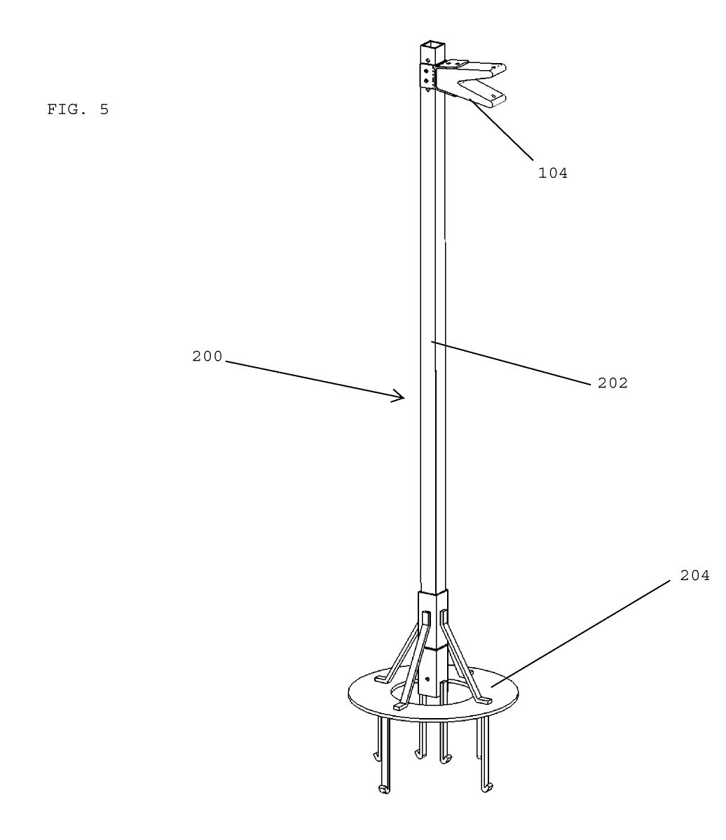

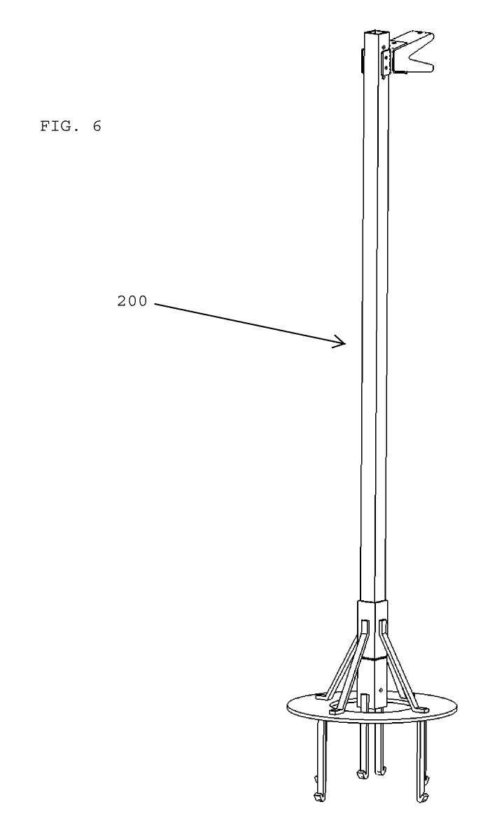

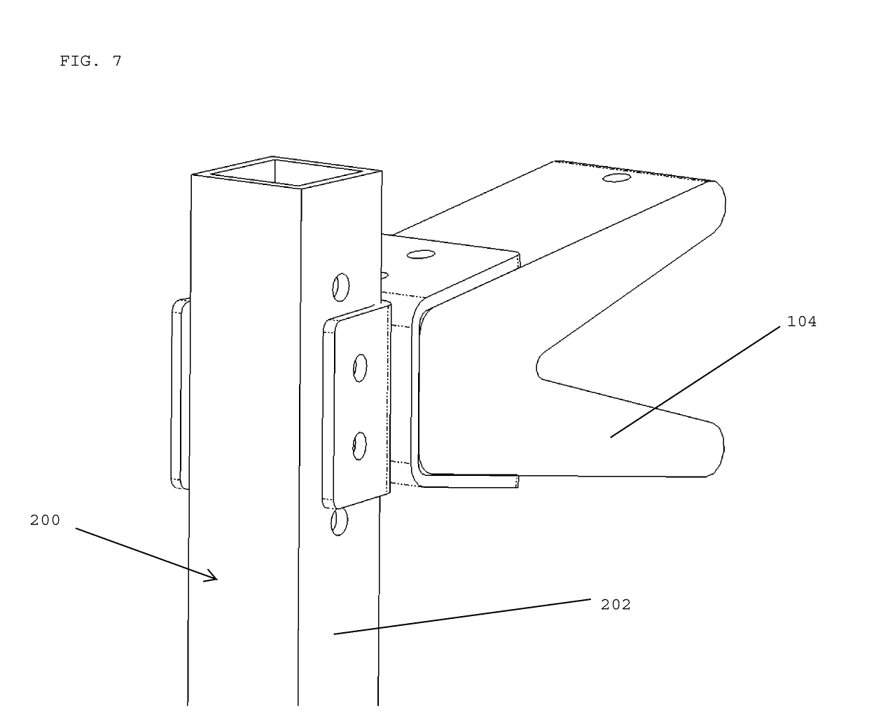

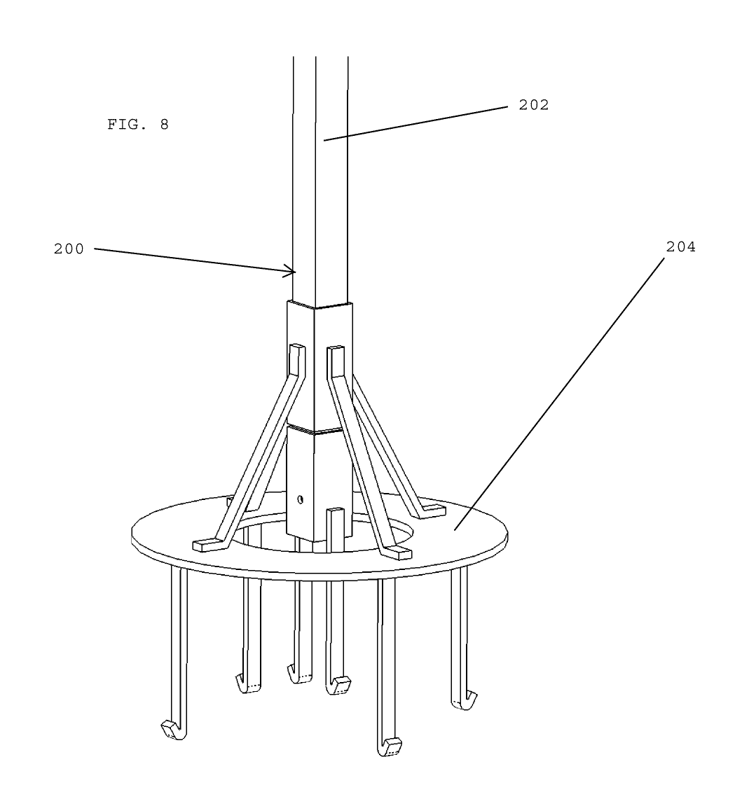

FIGS. 5 to 9 illustrate a second holder embodiment 200 which is configured to support a branch, tree trunk or other foliage where there are no existing trees or structures suitable for supporting the weight required. Some fields or plots do not have any existing adjacent trees or structures that are sturdy enough to support the weight of a branch or tree cantilevered out 5 yards or more. The adjacent cover may be brushy or suitable trees may be not be near the particular area where the overhang is desired. For such installations, holder 200 provides a ground support system that permits an appropriately sized branch or trunk to be secured to create the desired overhang. It is anticipated that holder 200 may be secured to shaft 202 by one of a variety of means, including but not limited to attaching with removable fasteners such as screws or bolts, riveting, welding, or friction. In one preferred usage, the desired branch would be positioned with the butt of the branch engaging the ground opposite where the overhang is desired. The branch would then be engaged by holder 200 so that the height of the support shaft 202 is sufficient to hold the overhanging foliage (opposite the butt) high enough off the ground to form effective cover or scrape.

A ground base 204 is configured one or more stakes or other stabilizing devices to secure holder 200 to the ground. Many animals for whom the overhanging foliage is intended to attract are naturally wary animals. They tend to shy away from new or unexpected features in their environment. For such animals, it is desirable that the overhang be established and allowed to become an accepted part of the animals environment. Thus, holders according the present disclosure should provide a stable base for the positioned foliage that will be stable for a period of months. Holder 200 is preferably provided with a base 204 that will secure the holder and the captive foliage for some time without collapsing or being knocked over by wind or other animals.

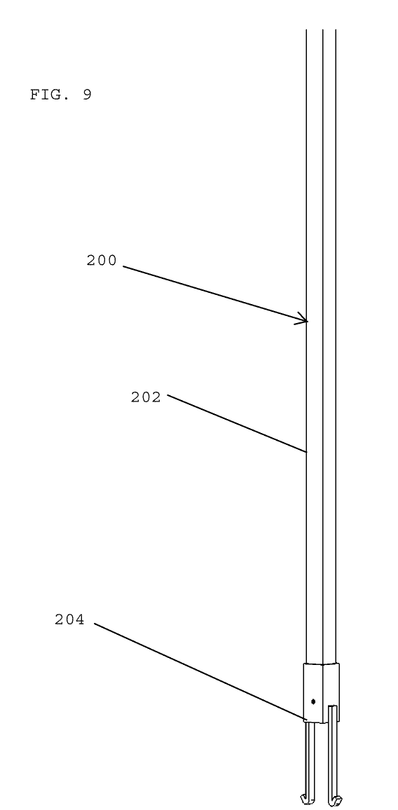

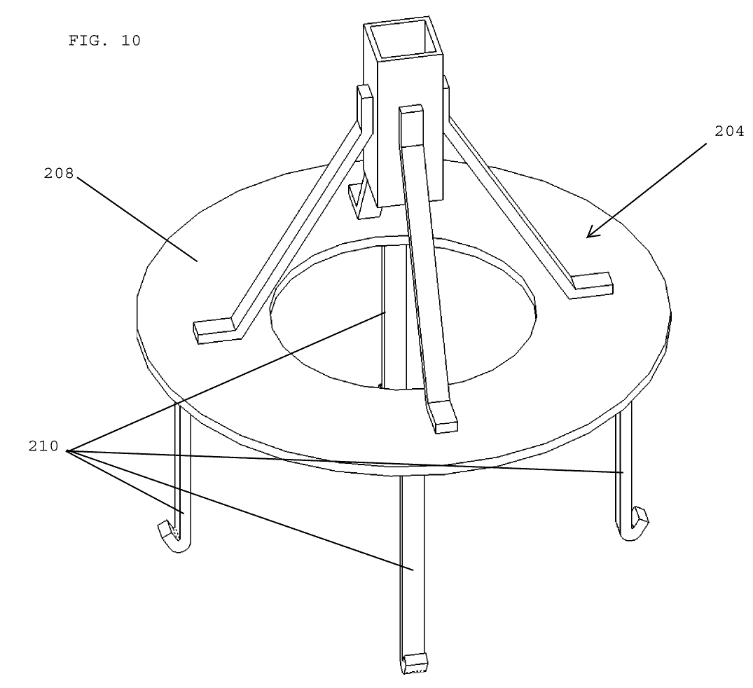

A variety of stable bases may be provided for holder 200 depending on the nature of the soil conditions where installation of overhanging foliage is desired. Swampy or sandy ground may require a broader baseplate 208 with deeper spikes or stakes 210, or a plurality of such stakes or spikes 210, such as shown in FIG. 10. Firmer drier ground may only require that one or more spikes be provided at the base to fix the holder securely in position, such as shown in FIG. 9. It is anticipated that a variety of bases may be used within the scope of the present disclosure, and also that a single base my be provided which is adaptable to a variety of conditions may be incorporated into holder 200.

It is also anticipated within the scope of the present disclosure that a variety of supports may be used for mounting a foliage holder according to the present disclosure. Holders according to the present disclosure may be mounted to existing trees, fence posts or other structures that may be located adjacent to an area where the addition of overhanging foliage is desired. It is also anticipated that one or a plurality of holders may be mounted to a single support and that a variety of foliage held by a single support. For example, a tree without sufficient lower branches or a post within the suitable forest clearing may have two or more holders attached with each holder having some foliage element extending from the support.

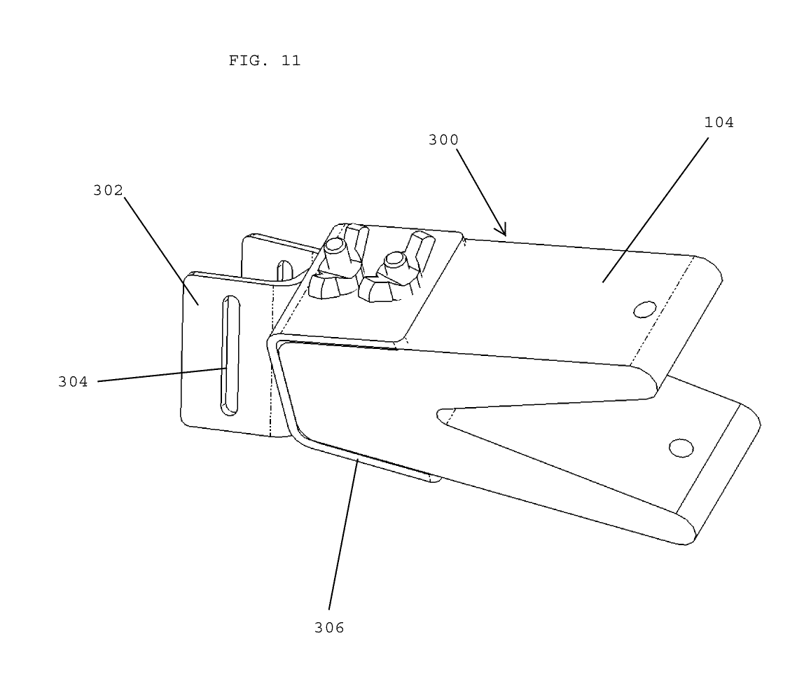

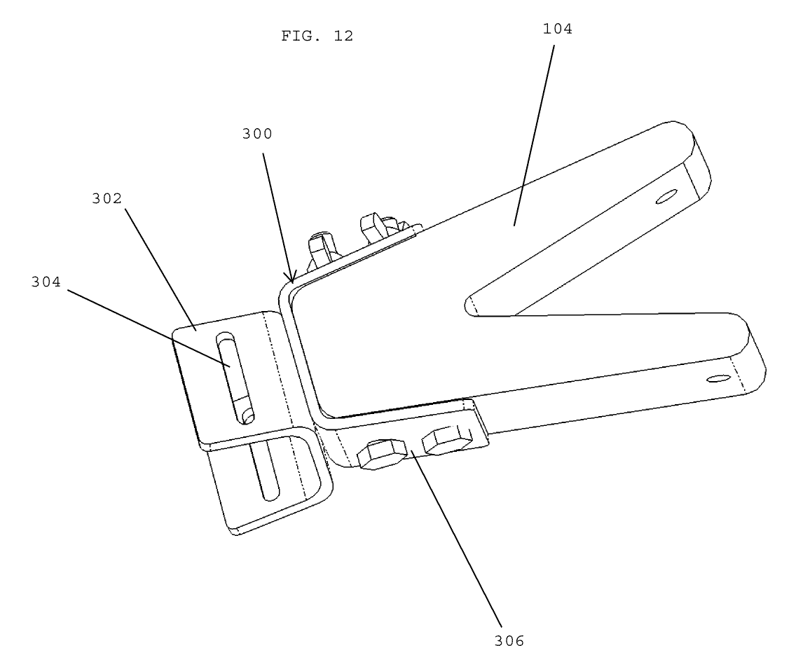

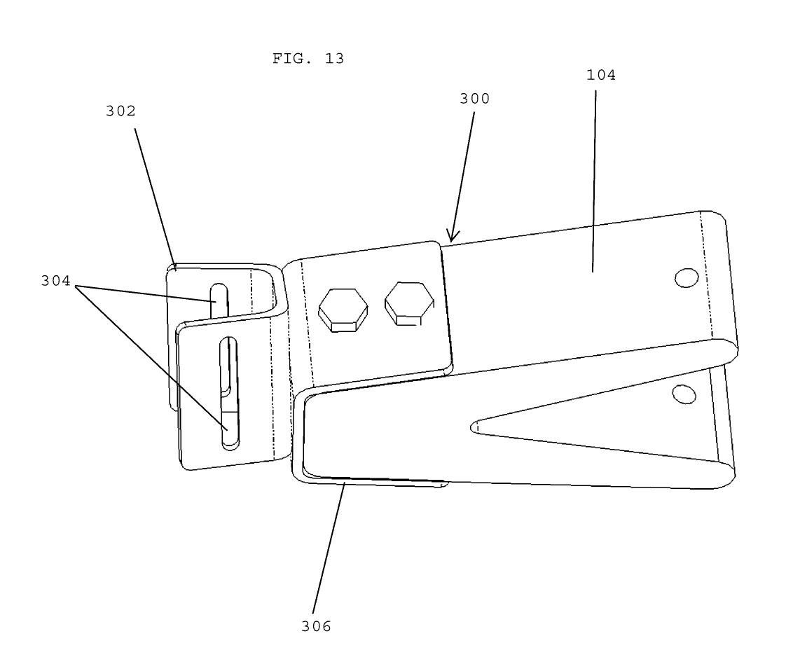

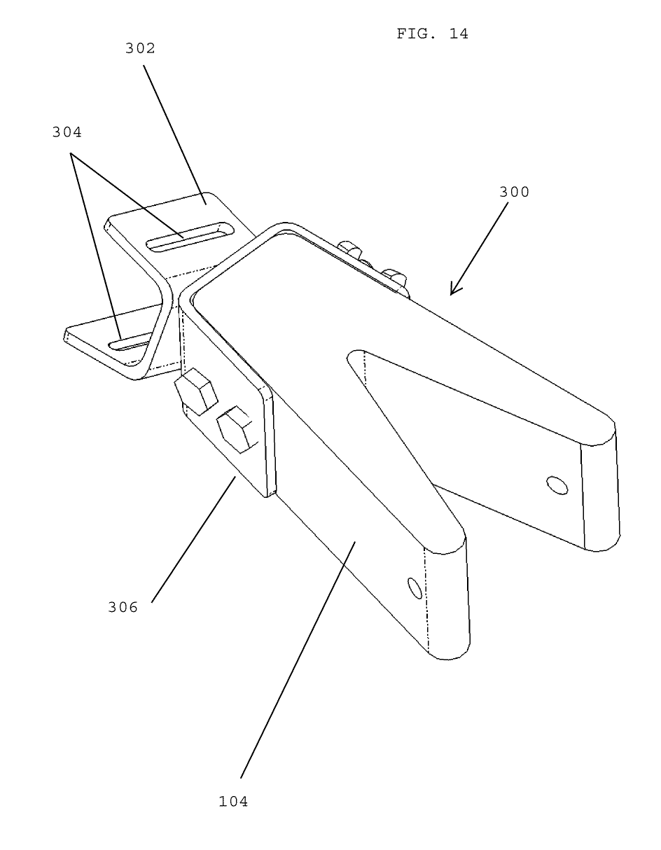

FIGS. 10 to 14 illustrate a third holder embodiment 300 according to the present disclosure. Holder 300 is similarly configured to holder 100 with the exception that the holder is intended to be strapped, bound or otherwise tied to the supporting structure or tree. A bracket 302 may be provided with one or more slots 304 to receive straps, lashing, twine, etc. for binding the holder 300 to a structure or tree. In some instances, it may be desirable or possible to screw into the existing structures or trees. For these instances, holder 300 permits a user to still provide overhanging foliage by securing the holder to the structure without damaging the structure. By having a strap on holder configuration, it may be possible to incorporate other devices that may assist the user in determining the effectiveness of the overhang once established. For example, cameras or other imaging devices may be strapped to the support with the holder and directed into the area beneath the overhang to identify how many and what types of animals may be utilizing the overhang.

Also note that holder 300 may include a second bracket 306 which receives support member 104. To provide for flexibility in mounting holder 300, brackets 302 and 306 may be pivotably fastened to each other. Referring now also to FIGS. 1 to 4, holder 100 may be similarly configured with brackets 114 and 116 permitting adjustment of the angle of V 106 when the holders are mounted to a tree or structure.

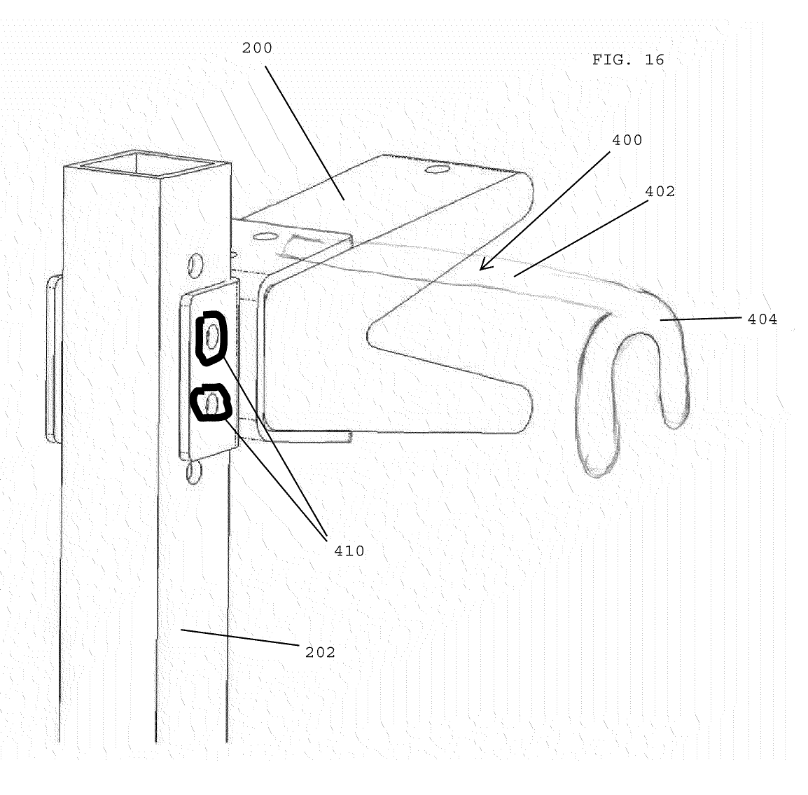

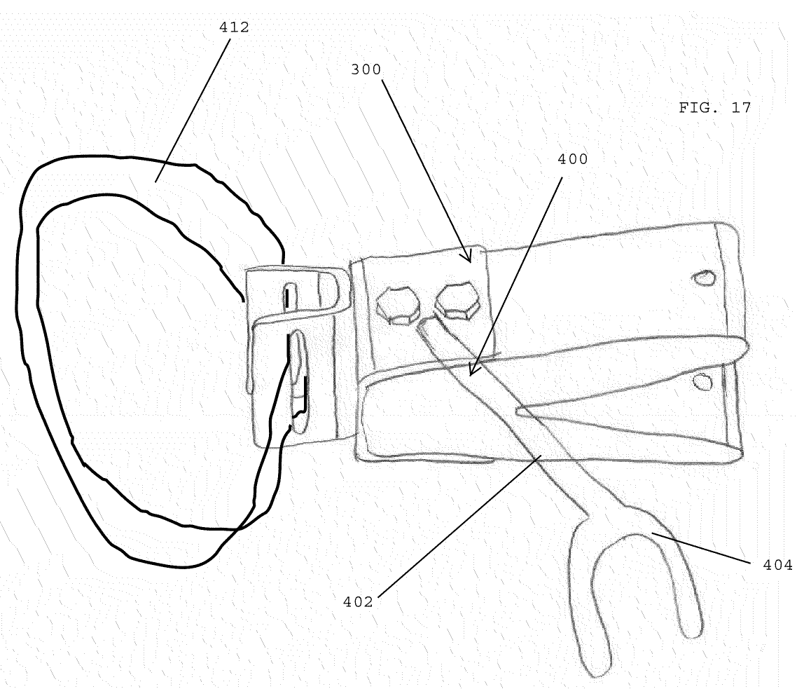

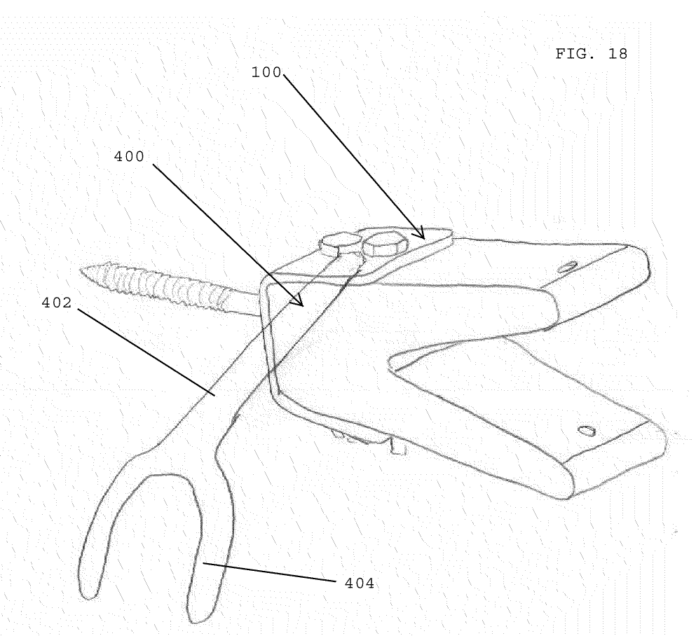

FIGS. 16 to 18 illustrate foliage holders 200, 300 and 100, respectively, with a support 400 attached to an upper portion of a bracket holding support member 104. In field trials, it was discovered that some branches or other foliage tended to sway unnaturally within foliage holders according to the present disclosure. Since it is desirable to mimic the action of naturally occurring foliage through the use of the holders of the present disclosure, experiments were undertaken to determine methods of holding foliage so that it responded to animal or wind contact in a natural fashion. As shown in FIG. 16, holder 200 may be secured to support 202 by removable fasteners 410. As shown in FIG. 17, holder 300 may be secured to a support by strap 412.

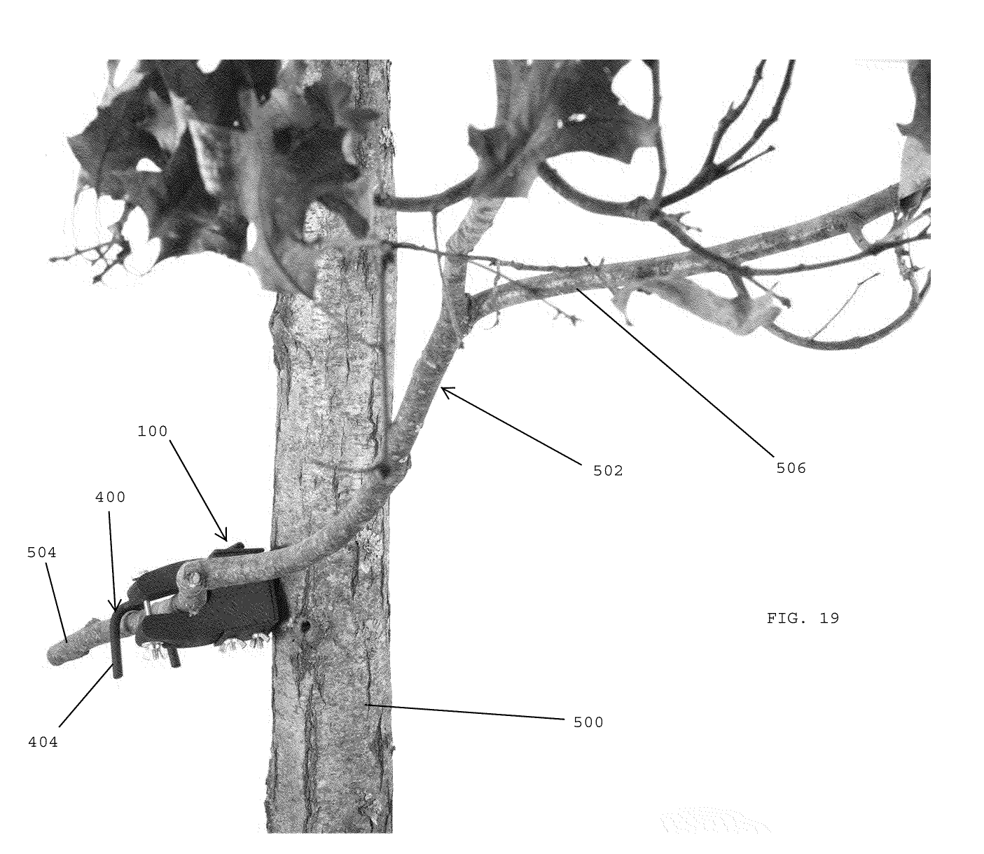

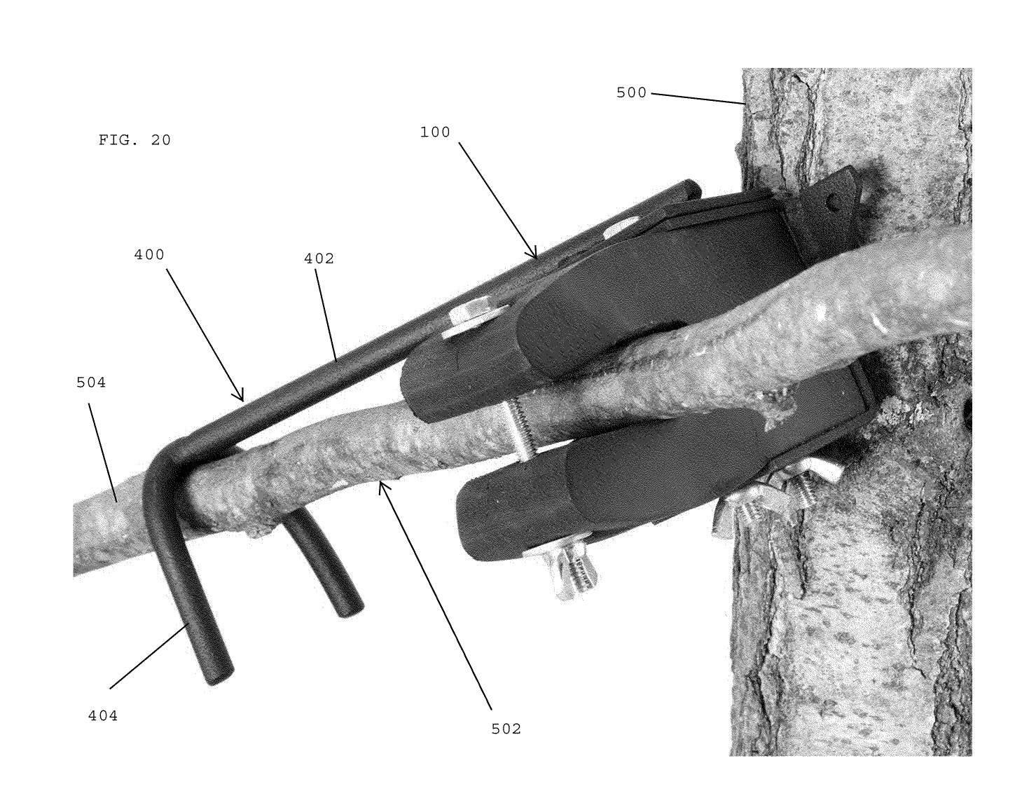

Support 400 may include a shaft 402 extending away from the brackets of the holder with a U-shaped and downward facing outer element 404 configured to receive the foliage being held by the respective holder. It is preferable that the butt end of the foliage being held, that is, the end of the foliage away from the desired overhanging portion, be received within element 404. So received in the support member and the support extending behind the support member, the foliage is better secured to the support but also constrained in movement in response to animal activity or wind. FIGS. 19 and 20 illustrate foliage holder 100 with support 400 secured to a tree 500 and holding a branch 502. A butt end 504 of branch 502 is received within element 404 and an overhanging end 506 extends away from foliage holder 100 is an opposite direction.

As shown in FIGS. 19 and 20, a single holder is used to secure a single piece of foliage to the selected support. It is anticipated that additional holders may be secured to a support such as tree 500, or any other suitable support, so that additional pieces of foliage may be supported to overhang by the same support. Such overhanging foliage may extend all in the same general direction or may extend in different directions from the support to provide overhangs about a greater portion of the support.

While a bracket 400 is shown, it is anticipated that other means of providing additional support to the butt end of a branch or other foliage held by a holder according to the present disclosure are within the scope of the present application. Examples may include, but are not limited to, a strap or rope that secures the butt end of the foliage to the support to which the foliage holder is secured, or stakes or similar ground securing devices that may be used to anchor the butt end to the ground opposite the overhanging portion.

Specific reference within the present disclosure has been made to deer and other antlered animal applications of the foliage holder. However, it is not intended that the present foliage holder be limited in use to a particular type or species of game or non-game animal. While deer may be particularly attracted to overhanging branches such as might be provided with the foliage holder of the present disclosure, other animals such as, but not limited to, bear, turkeys, coyotes, and other animals may also find overhanging branches or foliage adjacent open spaces to be desirable. The animals attracted to such foliage may use the foliage for different or similar purposes but it is undisputed that overhanging foliage adjacent open spaces is desirable.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A foliage holder comprising:
a support member including a pair of arms defining an open ended V for receiving a piece of foliage;
a bracket secured to an end of the support member opposite the open ended V;
the bracket including a means of securing the holder to a support to hold the holder above the ground;
a securing means to urge the arms of the support member inward to grip the foliage.

2. The foliage holder of claim 1, further comprising the means for securing the holder to the support is a screw extending oppositely from the open ended V.

3. The foliage holder of claim 1, further comprising the means for securing the holder to the support is a strap extending through a second bracket positioned opposite the open ended V.

4. The foliage holder of claim 1, further comprising the securing means to urge the arms inward is a screw extending through an opening in each of the arms.

5. The foliage holder of claim 1, further comprising a butt end support for engaging a butt end of the foliage on a side of the support member opposite an overhanging portion of the foliage.

6. The foliage holder of claim 1, further comprising the butt end support is a support bracket extending from the bracket secured to the support member.

7. The foliage holder of claim 1, further comprising the support member made from a resilient deformable material.

8. The foliage holder of claim 1, further comprising the holder is configured to be secured to a tree.

9. The foliage holder of claim 1, further comprising the support member secured to the bracket by a plurality of removable fasteners.

10. A method of providing overhanging foliage adjacent an open space in a wooded area, the method comprising;
providing a foliage holder including a support member with a pair of arms defining an open ended V and made from a deformable resilient material, a compressing means of compressing the open ended V of the support member inwardly, and a securing means to secure the holder to a support;
selecting a support located adjacent the open area;
selecting a suitable piece of foliage to be extended to overhang over the at least a portion of the open space;
securing a foliage holder to the selected support with the securing means;
placing the selected foliage into the open ended V of the holder with a butt end portion extending from the holder away from the portion of the open space where the overhang is to be defined;
compressing the support member inwardly about the foliage with the compressing means.

11. The method of claim 10, further comprising providing the holder includes a butt end support bracket and placing the selected foliage into the open ended V so that the butt end portion of the foliage extends through the butt end support bracket.

12. The method of claim 10, further comprising selecting a second piece of suitable foliage and using a second foliage holder to secure the second piece of foliage to the support.

13. The method of claim 10, wherein the selected support is a tree adjacent the open area.

14. The method of claim 10, wherein the selected support is an artificial support positioned as needed to hold the selected foliage.

15. The method of claim 10, wherein the foliage holder is secured to the support by a threaded shaft driven into the support.

16. The method of claim 10, wherein the foliage holder is secured to the support by removable fasteners.

17. The method of claim 10, wherein the foliage holder is secured to the support by a strap extending through as second bracket of the foliage holder, the second bracket located oppositely from the open ended V.
